(19) United States
(12) Patent Application Publication
(10) Pub. No.: US 2008/0228868 A1
(43) Pub. Date: Sep. 18, 2008

(54) SYSTEM AND METHOD PROVIDING SUBJECTIVELY RELEVANT CONTENT

(76) Inventor: Stephen M. Sivakoff, Fairfield, CT (US)

Correspondence Address: Stephen M Sivakoff, 1783 Jennings Road, Fairfield, CT, 06824, US

(21) Appl. No.: 12/019,465

(22) Filed: Jan. 24, 2008

Related U.S. Application Data
(60) Provisional application No. 60/897,363, filed on Jan. 24, 2007.
(60) Provisional application No. 60/958,966, filed on Jul. 10, 2007.

(51) Int. Cl. G06F 17/30

(52) U.S. Cl. 709/203; 434/350; 725/109; 707/E17.111

(57) ABSTRACT

A system and method for providing subjectively relevant content to a user by determining whether requested content or the source of the requested content is associated with attributes correlating to a user profile.

### CROSS REFERENCE TO RELATED APPLICATIONS

This application claims the benefit of provisional patent applications Ser. No. 60/897,363, filed Jan. 24, 2007, and 60/958,966, filed Jul. 10, 2007, both of which applications are incorporated herein by reference.

### FIELD OF THE INVENTION

The invention relates to the field of communications and, more specifically, to providing subjectively appropriate and relevant information to a user.

### BACKGROUND

Presently, parents address their children's online activities via hardware and/or software firewalls, basic filtering products and/or application-level privacy settings. Firewall and filtering products generally operate by updating lists of banned websites and preventing access to listed websites. Privacy settings may be used to prevent access to websites lacking a particular privacy policy or prevent applications from executing code retrieved from a website.

Presently, content providers, interactive service providers, social networks and the like are being pressured to provide a secure environment for their young users. If they fail to convince parents that these environments are secure or “appropriate” according to some reasonable criteria, then parents will prohibit access.

### SUMMARY OF THE INVENTION

Various deficiencies of the prior art are addressed by a method, system, software tool and apparatus adapted for managing and guiding user interaction with content sources via, for example, the Internet. Generally speaking, a guided Internet experience is provided wherein the retrieval of irrelevant and/or inappropriate content is avoided by determining whether accessed content and/or accessed content sources are associated with attributes correlating to, illustratively, academic curriculum, philosophical/moral leanings and/or other user criteria.

In one embodiment of the invention, student tracking and measurement is correlated to a curriculum such that student progress may be assessed. In an extension of this embodiment, individual student correlations are compared to similarly situated students in a secure manner to help assess the probability of student educational goals and aspirations.

### BRIEF DESCRIPTION OF THE DRAWINGS

The teachings of various embodiments can be readily understood by considering the following detailed description in conjunction with the accompanying drawings, in which:

FIG. 1 depicts a high-level block diagram of the communications system adapted according to an embodiment of the present invention;

FIG. 2 graphically depicts a sequence of steps useful in understanding the invention; and

FIG. 3 depicts a high-level block diagram of an alternate embodiment of the invention.

To facilitate understanding, identical reference numerals have been used, where possible, to designate identical elements that are common to the figures.

### DETAILED DESCRIPTION

The invention will be primarily described within the context of a student or child accessing the Internet, wherein various embodiments of the invention analyze such access and/or other computer interactions to either guide the student towards subjectively relevant information or prohibit access by the student of subjectively irrelevant or inappropriate information. It will be appreciated that the user need not be a student. The term “student” as used herein should be broadly construed as any user accessing a communication network such as the Internet wherein the user is guided towards subjectively relevant information, denied access to subjectively irrelevant or inappropriate information, or served according to the various tools and methodologies described herein.

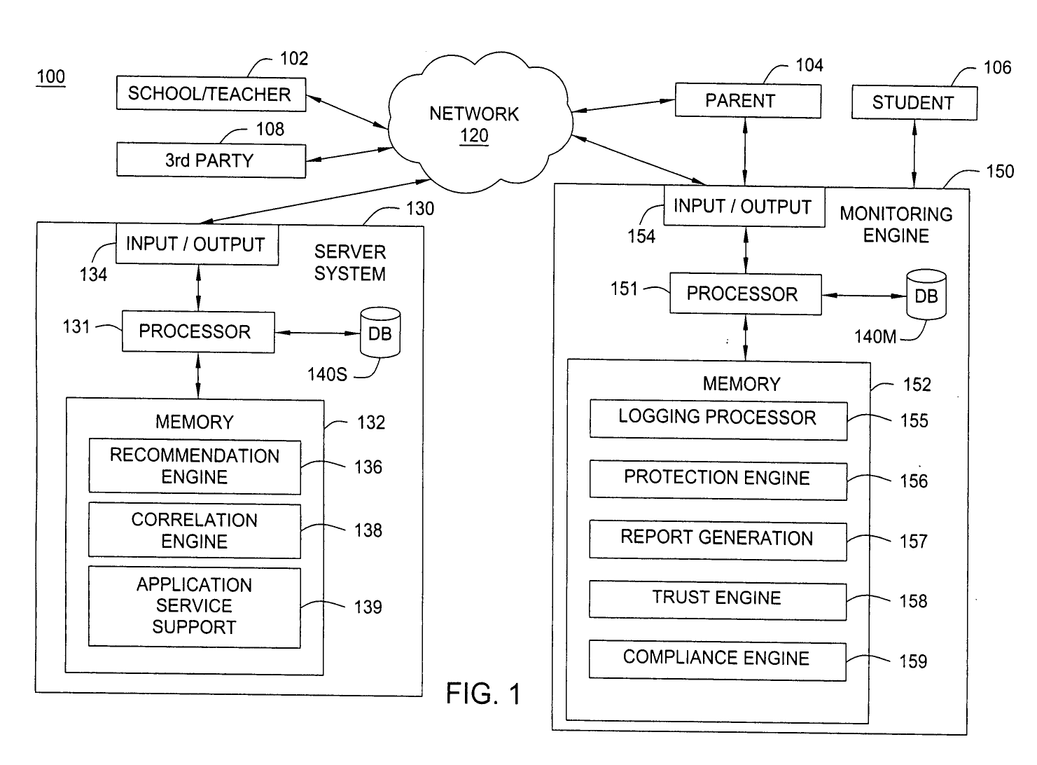

FIG. 1 depicts a high-level block diagram of a communications system adapted according to an embodiment of the present invention. Specifically, a communications system 100 comprises a network 120 such as the Internet which facilitates communication between each of the plurality of network elements or nodes associated with respective entities. As illustratively depicted in FIG. 1, the network 120 is in communication with a school/teacher 102, a parent 104, third parties 108 and various other network elements, nodes, computers and the like associated with various websites. While not specifically shown, it will be appreciated that numerous sources of content are also connected to the network 120, such that any type of content may be accessed by a student network element or other network element using the network 120. In short, millions of computers, computing systems and other networks are accessible via the network 120.

A server system 130 and monitoring engine 150 provide various application services via the network 120. An entity denoted as a student 106 (e.g., a computer used by a student) accesses the network 120 via the monitoring engine 150. As is well known, each of the various entities accessing the network 120 comprises computing devices, communication devices and the like suitable for supporting such access. Further, while the monitoring engine 150 is depicted as a distinct element between the student entity 106 and network 120, portions of the monitoring engine 150 may be implemented within the student entity 106 and/or the server system 130. As such, it will be appreciated by those skilled in the art that the functions described herein with respect to the various embodiments are may be implemented within the server system 130, monitoring engine 150, and/or student entity 106.

The monitoring engine 150 comprises a processor 151, memory 152, input/output (I/O) device 154 and mass storage device 140M. The memory 152 is used to store software instructions which, when executed by the processor 151, implement a logging processor 155, protection engine 156, a report generator 157, a trust engine 158 and a compliance engine 159. A data base DB is stored within the mass storage device 140M.

The monitoring engine 150 operates to analyze Internet usage patterns associated with the student 106 and correlate such usage with subjectively relevant criteria, such as topical educational subject matter. Internet usage is recorded by the monitoring engine 150. In one embodiment, the monitoring engine 150 operates as a resident application within the student's computer. In another embodiment, the monitoring engine operates as an application within a separate computing device, such as a hardware firewall device, a router or gateway device and the like. Since the optional monitoring of some functions requires access to the student computing device (e.g., keystroke monitoring and the like), some students computer resident software is optionally required to monitor those functions.

The logging processor 155 operates to record a user's computer input/output and Internet usage, including but not limited to webpage accesses, emails sent and received, instant messages, and voice over Internet Protocol (VOIP) communications. The logging processor 155 records all this information as a protected audit trail (PAT) that is stored in the local database (within mass storage device 140M) in/or server database (within mass storage device 140S). The PAT may not be modified by the student/user. Other usage is optionally monitored and stored, such as tables indicative of appropriate/relevant subject matter, user profile information, unprocessed activity logs, activity logs indicative of positive correlated activity and/or negative correlated activity and the like. In one embodiment, the activity log also includes identifying information such as data pertaining to user typing rhythms, biometric information, personal information and the like.

The protection engine 156 operates to block impermissible activities, such as surfing to websites with obscene or offensive content or images. In various embodiments the protection engine 152 maintains both a blacklist of known offensive websites (stored in this exemplary embodiment in a local database 158, or alternatively accessed from a remote source) and a method for evaluating content. The protection engine may be implemented using a third-party application or software layer.

The report generator 157 is responsible for summarizing and categorizing the Internet usage into reports for display to, illustratively, parents or users. The report generator 157 optionally includes functionality for visualization and statistical summary. A parent 104 may access the report generator to view a student's computer activity and/or an analysis of that activity. The report generator provides actionable intelligence to a parent by converting the flat file data derived from the PAT to a filtered subset of useful data.

The trust engine 158 provides identity validation using a plurality of factors, such as user name, password and so on. An optional pattern recognition algorithm is used to determine identification based on usage patterns, typing rhythms, challenge question and the like. A biometric identifier and/or other user indicative mechanisms are optionally used. The trust engine may be implemented using a third-party application or software layer.

The compliance engine 159 accesses the protected audit trail PAT to identify patterns of activity indicative of illegal and/or offensive behavior, such as the bullying and the like. In one embodiment, the compliance engine 159 associates the identified patterns with relevant federal, state or local statutes, school codes of conduct and the like to determine whether the activity may be legally actionable or actionable within the context of a school disciplinary system. Optionally, the activity and the relevant federal, state or local statutes, school codes of content and the like are combined in a report for use by law enforcement or education authorities. In this manner, bullying or other illegal in/or offensive behavior may be identified and mapped to the relevant legal or educational mechanisms to provide thereby and easily presentable claim for relief from the activity or punishment of the perpetrator.

In one embodiment, the compliance engine 159 applies modular standards based on components of a profile via neural network processes to determine a level of automation of the compliance engine. In this manner, a self-correcting compliance engine achieves efficiency in terms of computational analysis by querying only those elements that a change from the previous querying session.

The server system 130 is depicted as including a processor 131, memory 132, input/output (1/0) 134 and mass storage device 140S. The memory 132 is used to store software instructions which, when executed by the processor 131, implement a recommendation engine 136, a correlation engine 138 and various application service support functions 139. A data base DB is stored within the mass storage device 140S.

A user/student profile may be provided by a user/student, parent, school or other entity. Moreover, a user/student profile may be determined based upon partial data such as grade level, age and the like using generic curriculum data and/or generic societal norms. Thus, in one embodiment, a school 102 enters student information into the server system 130 using a web interface or application provided via application server supports 139 and accessed via the network 120. The application includes data input functionality and display support functionality adapted to facilitate data entry and whichever format is supported by the school information technology infrastructure. In an alternative embodiment, a parent 104 enters this data. The application stores this information in a database within mass storage device 140S.

A client-side application that adapts received content and, optionally, transmits content requests to ensure that the student's online activities are appropriate and valuable according to an established profile. A profile includes a plurality of criteria which a parent selectively controls. The criteria include child's academic level, emotional intelligence level, cultural norms and the like. By adapting these various controls, a parent may emphasize or deemphasize the appropriateness and/or value of various content sources, content types and so on. One control analogy is of multiple dials representing corresponding profile items, each of the dials being adaptable from one extreme to an opposite extreme through each of a plurality of settings there between. Various communities have certain cultural norms, each of which may be used to populate a cultural portion of a user profile. Various schools and grades have curricula which may be used to populate an educational portion of a user profile.

From an appropriateness perspective, content that is normally not objectionable may be filtered where parental controls and/or user profiles indicate such content is not appropriate. Where received content is inappropriate due to a level of complexity (e.g., academic level), replacement content of appropriate complexity is automatically retrieved and presented to a user in place of the inappropriate content. Where received content is inappropriate due to cultural sensitivity, replacement content may also be retrieved and presented to a user.

Where received content is inappropriate due to a lack of value (e.g., time wasting, game-related and the like), the content is made unavailable in one embodiment. In an alternate embodiment, the content is flagged as irrelevant or inappropriate and stored for subsequent inspection by, for example, a parent. By linking with or having knowledge of school curriculum, vetted content sources are accessed to provide relevant, valuable and appropriate information to the student.

The Recommendation Engine 136 comprises a recommendation generator, a client update recommender, and a report generator. The recommendation engine 136 operates to identify content and/or content sources responsive to the particular needs of a user. Thus, a user interested in a particular topic provides computer input indicative of such interest (e.g., search or query terms). The recommendation generator retrieves content and/or content source information responsive to such indication. Such retrieval is performed directly as a search. Alternatively, such retrieval is performed as a post filtering mechanism applied to the results of a third-party search based on the indication of interest.

The Correlation Engine 138 accepts information from the Recommendation Engine 136. The correlation engine utilizes the student profile to determine if the recommended content is appropriate for the student in accordance with parental controls. Appropriate content is forwarded to the student. The correlation engine 138 uses internal and third-party sources 110 in combination with an internally maintained database 140 of globally restricted content and domains to further restrict access to irrelevant information and encourage access to relevant information. Reporting function of the correlation engine 138 and/or recommendation engine 136 reports such information to students 100, parents 104, and/or schools 102.

In one embodiment, the correlation engine is an artificial intelligence (Al) system adapted to learn from each previous recommendation to improve thereby the relevance of subsequent recommendations. In one embodiment, correlation engine is adapted to improving the quality of the returned content to the user in terms of relevancy as well as appropriateness. One goal is to provide maximally relevant content to the user.

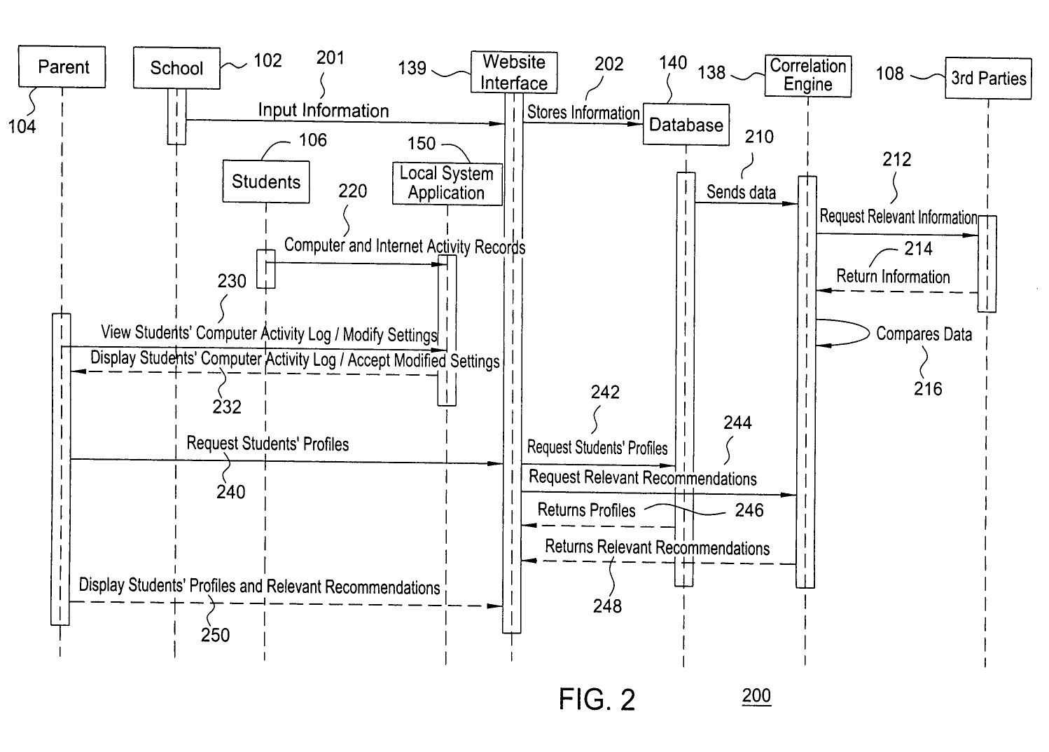

FIG. 2 graphically depicts a sequence of steps useful in understanding the invention. Specifically, FIG. 2 depicts actions and/or communications between the following entities are functional elements: parents 104, schools 102, students 106, student monitoring engine 150, server system website interface 139, database 140, correlation engine 138 and third parties 108. Generally speaking, FIG. 2 depicts an exemplary sequence of steps for implementing a system of analyzing Internet usage and correlating usage patterns with a student's curriculum.

At step 201, a school 102 provides curriculum information to the server system 130 via a website interface (server interface) 139. At step 202 the information is stored in the database with a mass storage device 140S. At step 210, the stored information is provided to the correlation engine 138. If the information is insufficient for proper correlation, the correlation engine 138 optionally requests additional relevant information at step 212 from third parties 108. The request information is returned to the correlation is 138 at step 214. At step 216, return information is compared to existing data such as curriculum data, student computer and Internet activity records and the like to identify whether or not a specific positive or negative activity has occurred. If additional third-party information is needed to, then steps to 212 and 214 are repeated.

At step 220, computer and Internet activity records are obtained by the monitoring engine 150 associated with a student 106.

At step 230, a parent 104 accesses the monitoring engine 150 to view student computer activity logs, modify profile settings and generally perform management functions associated with the students computing activities. At step 232, the monitoring engine 150 returns any desired information to the parents 104, such as activity logs, confirmation of excepted modified settings and the like.

At step 240, a parent 104 requests students profiles from the server system 130 via a website interface (server interface) 139. Student profile requests are propagated to the server database at step 242, the requested information being returned from the database at step 246. Similarly, relevant recommendation requests are propagated to the correlation engine 138 at step 244, the requested recommendations being returned from the correlation engine 138 at step 248. At step 250, the server system 130 returns any desired information to the parents 104, such as student profiles, relevant recommendations and the like.

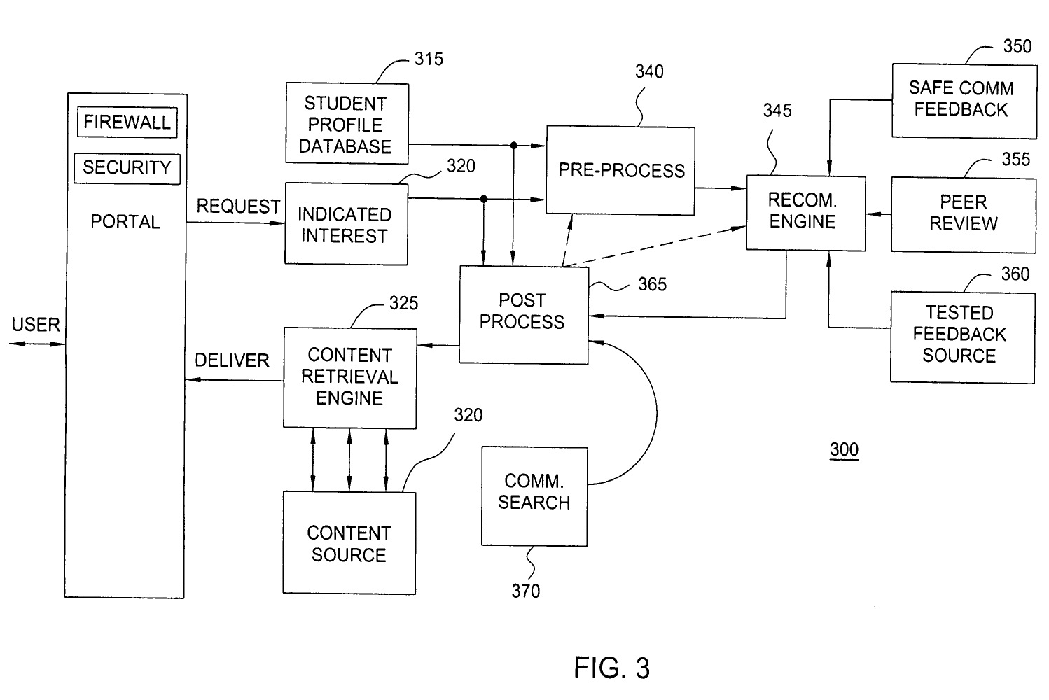

FIG. 3 depicts a high-level block diagram of an alternate embodiment of the invention. Specifically, FIG. 3 depicts a high-level block diagram of a plurality of functions useful in implementing an application service according to an embodiment of the invention. The various functions described herein with respect to FIG. 3 are also applicable to the embodiments of the invention described elsewhere including with respect to FIGS. 1 and 2.

Generally speaking, a user communicates with a portal 310 to provide requests for content and receive delivered content. In a preferred embodiment, the user communicates only with the portal to access content. After processing, information returned to the user may be provided directly from the information source or passed through the application portal as necessary. The portal includes standard features such as a firewall, a security program and other features. The features described herein with respect to the portal and other functional elements may be distributed between the server side such as by an application service provider (ASP) or software as a service (SAS) provide, as well as a client device used to access the Internet.

Referring to FIG. 3, a user request is propagated via an indicated interest database 320 to a preprocessing element 340 and a post processing element 365. In addition, corresponding information from a student profile database 315 is propagated to the preprocessing element 340 and post processing element 365. The preprocessing element 340 operates to provide initial screening/correlation of indicated interest content to student profile information and propagate a content request to a recommendation engine 345.

The recommendation engine 345 operates to retrieve content or content source identifiers (e.g., URLs) in response to the propagated request. The recommendation engine performs various processing tasks to determine whether the particular content or content sources are appropriate for the user and relevant to the indicated content interest. As a first approximation, the recommendation engine utilizes profile information, demographic information and the like to determine whether particular content may be useful/appropriate. The recommendation engine utilizes feedback from one or more feedback sources such as a feedback community 350, a peer-reviewed entity/database 355, a trusted feedback source 360 and the like.

In general, the recommendation engine 345 iteratively searches and filters according to various criteria appropriate to the student, including one or more of student goals/aspirations, profile information and/or other factors associated with the student or the student's family (e.g., moral codes, religious beliefs and the like).

The feedback mechanism 350 provides individual or aggregated recommendation information determined by the server systems based upon one or more users prior experiences. The feedback community 350 is implemented in one embodiment by enabling a user comment mechanism for content viewed by the other users. That is, as a community of users increases, the satisfaction or lack of satisfaction associated with content offerings is indicated by users and collected into the feedback mechanism, which in turn is used to help guide subsequent users.

The peer-reviewed entity/database 355 provides recommendation information generated by scholars, educators and/or other individuals or organizations. The peer-reviewed entity/database 355 comprises one or more organizations tasked with determining the appropriateness of content with respect to particular age groups, moral perspective and the like. These organizations may have a particular bias which is made known such that those agreeing with the agenda may accept the verdict of the organizations with respect to particular content and/or content sources.

The trusted feedback source 360 provides recommendation information from specific entities that have achieved a high degree of trust. The trusted feedback sources 360 comprise those other mechanisms by which information relevant to accepting or rejecting content for a particular student may be derived. A trusted feedback source may be a known good source of content where everything produced by the source is deemed to be acceptable (e.g., age appropriateness determinations are trusted, content is of sufficient quality, etc.).

The recommendation engine 345 propagates recommendations to post processing element 365 for further processing. The post processing element 365 performs various filtering and correlation functions adapted to ensuring that recommended content is indeed appropriate to the users/student. Optionally, the post processing element 365 may determine that the recommended content is inadequate in some respect such that further preprocessing or refinements of the recommendation criteria are necessary. In these cases, the post processing element 365 communicates with one or both of the preprocessing element 340 and recommendation engine 345 to modify the request criteria processed ultimately by the recommendation engine 345.

Optionally, output from common search tools may be provided to the post processing element 365. In this manner, basic search results may be processed according to various criteria to provide thereby subjectively relevant and appropriate search results to a user.

After post processing, recommended content-indicative information is propagated to a content retrieval engine 325 which in turn retrieves the recommended content from various content sources 330. The retrieved content is then delivered to the user via the portal 310.

It is important to note that all the processing steps described herein with respect to FIG. 3 are optionally performed as part of a service application remote from the user such that the processing overhead and complexity is avoided by the user. Each of the various functional elements are updated as necessary and scaled to meet the needs of many users. As the user base increases, the value of the information processed also increases such that the recommendations and relevancy of content provided to users improves continually.

The above-described embodiments of the invention may be implemented within the context of methods, computer readable media and computer program processes. As such, it is contemplated that some of the steps discussed herein as software processes may be implemented within hardware, for example as circuitry that cooperates with the processor to perform various steps.

The invention may also be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a signal bearing medium such as a broadcast medium, and/or stored within a working memory within a computing device operating according to the instructions.

In one embodiment of the invention, a hardware firewall device is adapted to perform various logging and reporting functions as discussed herein.

In one embodiment, the monitoring function and/or other functions are adapted over time in response to patterns of standard behavior such that the processing/storage loads imposed on a computing device may be reduced by ignoring certain normal or standard activities undertaken by the user.

It should be noted that it is not necessary to perform all of the above-described steps in the order named. Furthermore, not all of described steps are necessary for the described method to operate. Which steps should be used, in what order the steps should be performed, and whether some steps should be repeated more often than other steps is determined empirically.

In one embodiment, a tool is provided to enable aggregated recommendations within the context of a social network platform. In adaptations of this embodiment, the various techniques and methodologies described above with respect to a single user are aggregated among a group of users such as classmates or social years or some other subset of users. Within the context of a social grouping, various embodiments facilitate identification of peers by learning the patterns of use, input, query style, and recommendation/appropriateness filtering associated with other students/users.

Various embodiments of the invention are included within a suite of tools and related services adapted to enable parents to improve the value and appropriateness of their children's online activities.

In one embodiment, the various software tools and functions such as described above enable the gathering of electronic usage patterns of clients and their at-risk users, and the analyzing of the usage patterns. The electronic usage patterns are compared to normalize patterns within a database to “grade” the quality and quantity of the electronic usage patterns to other clients and users with similar age/grade levels with similar aspirations and goals. In this manner, individual students may be benchmarked to determine if they are on track to achieve desired goals (such as admission to a particular university).

In one embodiment, protection from online predatory behavior and identity theft is provided. In this embodiment, the data usage patterns are analyzed and suggestions are made regarding appropriate modification in online behavior to avoid such problems. Optionally, an emergency alert system is provided to immediately inform parents or users to particularly dangerous or egregious online activities.

One embodiment provides a customized reward system for academic progress correlated to computer readable curriculum computing. A safe electronic “coc oon” surrounding the user identifies the user in a validated manner, thereby allowing for guaranteed message delivery and verification that the user is authorized to be acting on his or her own behalf. This further assists in avoiding fraud and identity theft.

One aspect of this service is that the usage patterns are tied interactively with the curriculum of their children's specific school in both and overall progression, as well as the daily and weekly topic areas. An additional service offered within the program suite is the ability to provide scheduled reports that are customized to easily translate the usage patterns and offer a graphical and numeric summary of the usage patterns.

In one embodiment, a database component is continually updated by an algorithm that recognizes patterns of activity.

The software platform and tools described herein are well adapted to help parents properly guide and educate their children. An application suite according to one embodiment includes a guided internet experience and a method for parents and students to receive age-specific and grade-specific educational media to support the academic, civic and ethical components of education, including online safety.

In other embodiments, components of the suite address foundational aspects of protection, guidance, and ethics. The suite provides a subscription based service that keeps parents aware of their children's individual scholastic progress and provides quantitative usage metrics of their children's local computing and on-line usage activities. The service keeps parents up to date regarding past, current and future assignments and testing results. The service also provides individualized notifications of urgent usage events.

In one embodiment, quantitative metrics are used to compare individual student usage patterns to a peer reviewed model of aspirational student usage patterns. In one embodiment, the recommendation engine is accessed via the service and suggests appropriate content based upon a student's needs and/or curriculum.

Recommended content may comprise internally produced content or selected externally produced content, such as educational or training resources. In this manner, a safe and qualitatively improved educational experience is provided while reducing information overload.

In one embodiment, recommended content is initially accepted or certified by an advisory board. Using information provided via alliances with educational and policy making institutions, the advisory board provides recommendations that improve the safety and comprehensive intelligence of students while reducing the cyber activity monitoring burdens placed on parents.

Various embodiments of the invention are included within a suite of tools and related services adapted to enable online media companies, content providers, interactive service providers, social networks, application vendors and the like to improve the value and appropriateness of their content to children. Specifically, pre-validating content or content sources, the content or content source may be included as a one of the trusted feedback sources 360. Moreover, pre-validating content or content sources enables preferential presentation of such content or content sources to users.

Various embodiments are implemented as a novel software suite that allows for gathering of the electronic usage patterns of clients and their at-risk users and analyzes the usage patterns in a context where the data is then correlated. The correlation takes usage patterns and compares them to a usage database to “grade” or otherwise classify the quality and quantity of the electronic usage patterns with respect to other clients and users with similar age/grade levels and/or with similar aspirations and goals. In addition, various embodiments/tools in the software package provide protection from online predatory behavior, identity theft and the like. An additional offering is analysis of the data usage patterns to provide thereby suggestions to clients regarding upcoming events, training, and multimedia offerings that could be of assistance with the development of their children.

One embodiment of the service is the correlation of usage patterns to the curriculum of a child's school with respect to overall progression and/or daily or weekly topic areas.

One embodiment of the service is the ability to provide scheduled reports that are customized to easily translate the child's usage patterns into actionable intelligence, such as by offering a graphical or numeric summary of the usage patterns along with recommendations of behavioral areas requiring positive or negative reinforcement. One embodiment of the service provides an emergency alert system to immediately inform that parents/guardians to particularly dangerous or egregious usage activities.

The architecture is, in one embodiment, platform independent and structured in a manner transparent to the end user. A customized reward system for academic progress correlated to computer readable curriculum is optionally provided (e.g., more non-relevant computer or TV time). A safe cocoon surrounding the user identifies them in a validated manner allowing for a guaranteed message delivery and verification that the user is authorized to be acting on their own behalf, thereby preventing and avoiding fraud and identity theft.

In one embodiment, a suite of tools is provided wherein each tool operates as a modular component within a suite of tools. The various tools implement various functions generally useful in supporting the overall purposes of the suite of tools. Each of the modular components is adapted to interact with at least one of the other modules or the platform itself. Modules may be updated independently, outsourced and so on.

One module comprises a search result processing tool adapted to automatically determine which search results are relevant and/or appropriate for a user such as a child. Various criteria are used to process the search results.

In one embodiment, source vetting criteria are provided. That is, HTML links (or other URL pointers) returned as part of search result are processed to determine whether or not the content pointed to by the link is associated with a trusted entity, such as a trusted university, school, publishing house, religious organization, social organization and the like. Trusted entities may be identified as such in an explicit manner. Trusted entities may also be identified with respect to the content generally associated with them. In the latter case, one embodiment operates to process content associated with various entities to identify factors such as subject matter, relevancy, appropriateness and the like.

In another embodiment, content is processed to identify appropriate grade levels and the like. In one embodiment, identified content (potentially relevant content) is processed using a grammar identification engine to determine a particular grade level associated with the vocabulary, grammar, subject matter, concepts and/or other parameters of the content.

In one embodiment, various tools within the suite may be conceptualized as filtering tools wherein inappropriate content is removed from the content set made available to a student. Inappropriate content may be defined as content associated with off-limits topics from the perspective of, for example, a parent of a student. Additional filtering tools further narrow the available content by removing irrelevant content from the content set made available to a student. Irrelevant content may be defined as content associated with time wasting websites, subjects other than a subject presently being worked on by the student and the like. For example, a student working on research associated with a science project likely does not need information associated with a musical interest to help with a project.

The above-described functions associated with the various engines and/or modules may be alternatively performed within different modules. Optionally, various processing functions primarily described as server processing functions may be performed at a client device (parent, student, user, child, etc.), while various functions primarily described as client functions may be performed at a server device. For example, the functions of the recommendation engine and/or correlation engine may be combined in a single functional element.

The above described embodiments may be implemented within the context of methods, computer readable media, and computer program processes. As such, it is contemplated that some of the steps discussed herein as methods, algorithms, and/or software processes may be implemented within hardware (e.g., memory and input/output circuitry that cooperates with a processor to perform various steps), software or a combination of hardware and software.

One embodiment may be implemented as a computer program product wherein computer instructions, when processed by a computer, adapt the operation of the computer such that the methods and/or techniques described herein are invoked or otherwise provided. Instructions for invoking the methods may be stored in fixed or removable media, transmitted via a data stream in a signal bearing medium such as a broadcast medium, and/or stored within a working memory or mass storage device associated with a computing device operating according to the instructions.

Although various embodiments have been shown and described in detail herein, those skilled in the art can readily devise many other varied embodiments that still incorporate the described teachings.

What is claimed is:

1. A system for providing a service to a customer, comprising:
A recommendation engine, for providing on-line content recommendations in response to a user request; and
a correlation engine, for determining which of the on-line content recommendation is relevant to a profile associated with a requesting user.
